(19) United States
(12) Patent Application Publication
(10) Pub. No.: US 2009/0259891 A1
(43) Pub. Date: Oct. 15, 2009

(54) DEFECT DETECTION APPARATUS FOR OPTICAL DISC AND METHOD THEREOF

(75) Inventor: Chin-huo Chu, Liu-Kuei Gsiang (TW)

Correspondence Address: KIRTON AND MCCONKIE, 60 EAST SOUTH TEMPLE,, SUITE 1800, SALT LAKE CITY, UT, 84111, US

(73) Assignee: MEDIATEK INC., Hsin-Chu (TW)

(21) Appl. No.: 12/331,250

(22) Filed: Dec. 9, 2008

Related U.S. Application Data
(60) Provisional application No. 61/043,458, filed on Apr. 9, 2008.

(51) Int. Cl. G06F 11/07

(52) U.S. Cl. 714/42; 714/E11.024

(57) ABSTRACT

Disclosed is a defect detection apparatus of an optical disk drive. The optical disc drive records a set of first data onto at least one data unit of an optical disc. The defect detection apparatus comprises an error detector and a defect verification unit. The error detector receives the set of first data, being recorded and the set of second data derived from the data unit of the optical disc, and then compares the set of first data with that of second data to generate error information of the set of second data. The defect verification unit determines whether the data unit is defective according to the error information. The object that the defect detection apparatus of the invention performs verification for can be a sector, an ECC Block or a cluster. The error detector can be a channel bit error detector, a byte error detector or a frame error detector.

### CROSS REFERENCE TO RELATED APPLICATION

This application claims the benefit of U.S. Provisional Patent Application Ser. No. 61/043,458, filed on Apr. 9, 2008.

### FIELD OF THE INVENTION

The invention generally relates to a defect detection apparatus and method thereof, and more particularly to a defect detection apparatus of an optical disk drive for performing verification for data derived from an optical disc and method thereof.

### BACKGROUND OF THE INVENTION

As shown in FIG. 1, it is a functional block diagram of a defect detection apparatus 10 for performing verification for optical data recording according to the related art. The recorded data is read from the optical disc and is demodulated and then transmitted to the buffer 130 of the defect detection apparatus 10. A PI direction decoding block 100 executes the PI check for an ECC block with a PI decoder 105. And a PO direction decoding block 400 executes the PO check for the ECC block with a PO decoder 405. The PI direction decoding block 100 and the PO direction decoding block 400 share the buffer 130 and a memory 200 for performing the PI check and the PO check respectively. And then, all checked result is transmitted to a defect verification unit 300 to determine whether the ECC block is uncorrectable. Thereafter, the verification may be interrupted at once for replacing defective data or transmitting defect address to the host for registration for replacing the defective data after all checks are completed. Therefore, the capacity of memory 200 has to be quite large for performing the PI check and the PO check at the same time.

Furthermore, conventionally, a Reed-Solomon decoder is necessarily employed for the PI check. Therefore, as aforesaid standard procedure for the PI check and PO check of the verification can only provide a solution result or a no-solution result for a row (frame), accordingly, the standard for the PI check and PO check has limitation of accuracy and deciding an active standard with high accuracy (such as for single byte) can not be realized for multiplicity of the optical disc technology today.

According to the specification of Blu-ray disc, similarly as aforesaid DVD, there is a standard for processing LDC (Long Distance Code) and BIS (Burst Indicating Code) check when the verification for one cluster of data is performed. The defect detection apparatus decodes the BIS to obtain error address to be marked as a picket. Because the BIS code carries address and control information and is strongly protected, therefore the BIS code can be properly decoded with higher probability, that is, BIS code can suffer more errors and is easier correctable. Then, the defect detection apparatus decodes the LDC code to perform erasure correction according to picket marked during encoding the BIS code. Therefore, the standard for the LDC and BIS check also has limitation of accuracy and deciding an active standard with high accuracy (such as for a sector) can not be realized for multiplicity of the optical disc technology today.

Consequently, there is a need to develop a defect detection apparatus for performing verification with high accuracy and for reducing memory usage of performing verification and method thereof.

### SUMMARY OF THE INVENTION

The defect detection apparatus for verifying a set of first data recorded onto a t least one data unit of an optical disc, wherein a set of second data is derived from at least one data unit of the optical disc after the set of first data being recorded. The detection apparatus comprises an error detector and a defect verification unit. The error detector receives the set of first data and the set of second data, and then compares the set of first data with the set of second data to generate error information of the set of second data. The defect verification unit is coupled to the error detector and determines whether the data unit is defective according to the error information. The error detector further comprises a comparator and an error counter. The comparator compares each unit of the set of first data with that of the second data to determine if the unit of the set of second data has an error or not. The error counter counts each error to obtain the error information of the data unit.

The object that the defect detection apparatus of the embodiments performs verification for can be a sector of DVD, an ECC Block (RSPC data block) of HD-DVD, or a cluster for Blu-ray disc. The error detector can be a channel bit error detector executing the comparing by each channel bit, a byte error detector executing the comparing by each byte, a frame error detector executing the comparing by each frame, a LDC (Long Distance Code) error detector executing the comparing by each LDC code, or a BIS (Burst Indicating Subcode) error detector executing the comparing by each BIS code. Furthermore, the embodiments may detect a position of data unit to ensure a Reed-Solomon decoding mechanism inside the defect verification unit decodes the data in a single direction and decodes the correct frame of the data unit to generate the error information. Alternatively, the embodiments may provide addresses carried from the BIS code for the LDC/BIS error decoding mechanism to ensure the LDC/BIS decoding mechanism decodes a correct LDC code or a correct BIS code.

One of the embodiments further provides a defect detection method for performing verification for a set of first data recorded onto at least one data unit of an optical disc with a set of second data derived from the data unit of the optical disc after the set of first data being recorded. The method comprises steps of comparing the set of first data with that of the second data to generate error information of the set of second data; and determining whether the data unit is defective according to the error information. The comparing step further comprises steps of comparing each unit of the set of first data with that of the set of second data to determine if the unit of the first data has an error or not; counting each error of the data unit to obtain an error number; and resetting the error number to zero according to a sector boundary signal or a cluster boundary signal.

Moreover, one of the embodiments further provides another defect detection method for performing verification with the defect detection apparatus corresponsively. The method comprises steps of: detecting a position of the data unit; decoding the data in a single direction to generate error information; and receiving the error information to determine if the data unit is defective.

According to the embodiments and method thereof, the defect detection apparatus performs verification for the set of second data derived from the data unit of the optical disc by comparing the set of first data recorded onto the data unit of the optical disc with that of the second data with high accuracy, better than using the Reed-Solomon decoding mechanism or the LDC/BIS decoding mechanism. Furthermore, as an option, detecting the position of the data unit or providing the addresses carried by the BIS code also promotes accuracy of performing verification. Significantly, the defect detection apparatus of the embodiments can reduce memory usage while performing verification for the set of second data derived from the optical disc.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a functional block diagram of the defect detection apparatus for performing verification according to the related arts;

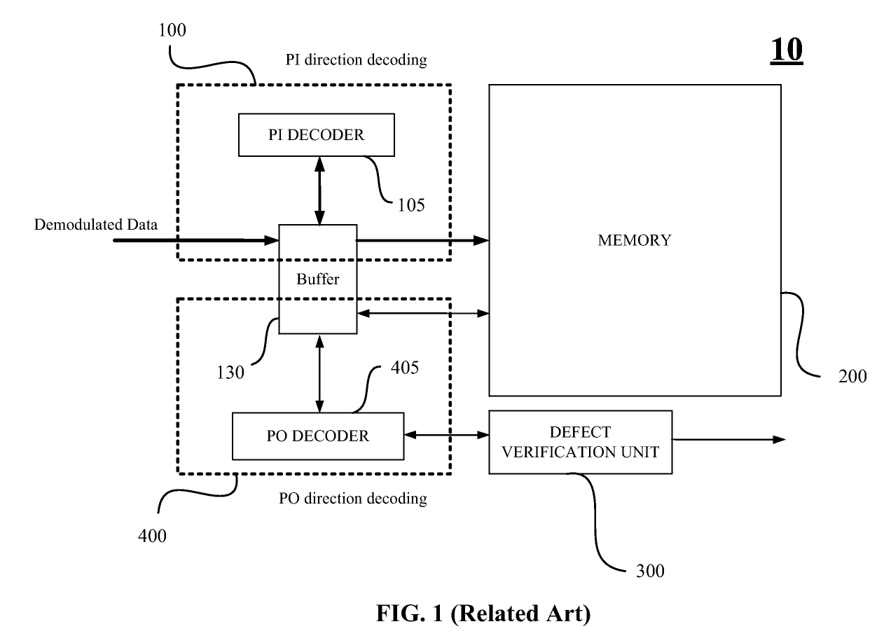

FIG. 2 illustrates a functional block diagram of the defect detection apparatus, comparing first data recorded onto an optical disc with second data derived from the optical disc by each byte according to a first embodiment of the invention;

FIG. 3 illustrates a functional block diagram of the defect detection apparatus, executing the comparing by each channel bit according to a second embodiment of the invention;

FIG. 4 illustrates a functional block diagram of the defect detection apparatus, executing the comparing by each frame according to a third embodiment of the invention;

FIG. 5 illustrates a functional block diagram of the defect detection apparatus, providing sync pattern information of each frame for the frame error detector according to a fourth embodiment of the invention;

FIG. 6 illustrates a functional block diagram of the defect detection apparatus, executing the comparing by each LDC code or each BIS code according to a fifth embodiment of the invention;

FIG. 7 illustrates a functional block diagram of the defect detection apparatus, providing addresses carried by the BIS code for the LDC/BIS error detector according to a sixth embodiment of the invention;

FIG. 8 illustrates a flowchart of a defect detection method for performing verification of the invention; and

FIG. 9 illustrates a flowchart of another defect detection method for performing verification of the invention.

### DETAILED DESCRIPTION OF THE INVENTION

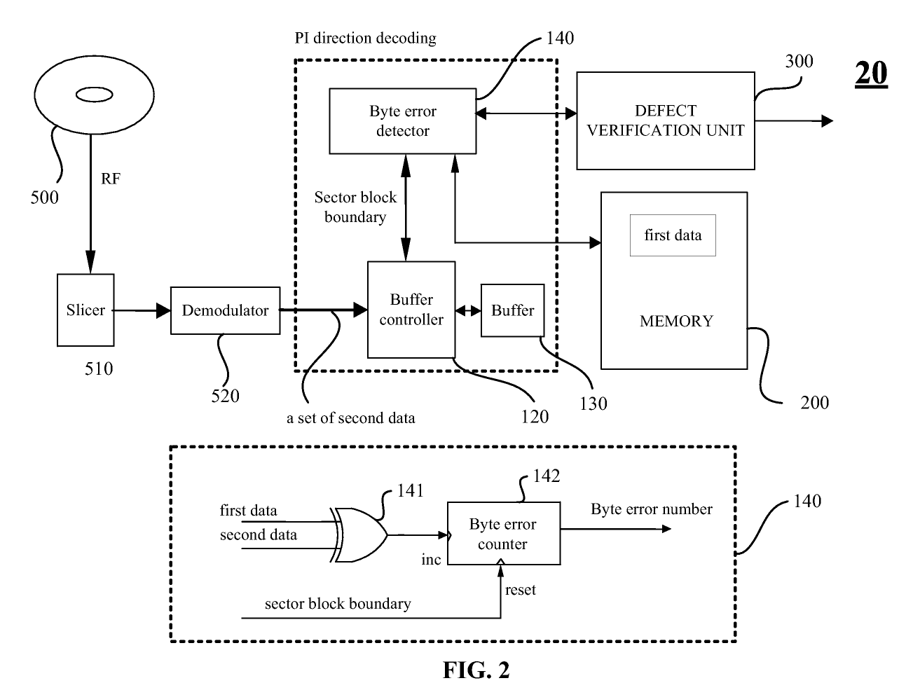

Please refer to FIG. 2, a functional block diagram of the defect detection apparatus 20, comparing a set of first data with a set of second data derived from at least one data unit of the optical disc 500 by each byte, according to a first embodiment of the invention is shown. The set of first data is a set of encoded host data prepared for recording onto at least one data unit of an optical disc 500. The set of second data is a set of demodulated data read from the data unit. Before recording the set of encoded host data to the optical disc 500, the set of encoded host data is stored in a memory 200 in this embodiment. The set of encoded host data is then recorded to the optical disc 500. After recording the set of encoded host data to the optical disc 500, the defect detection apparatus 20 performs verification for the recorded set of encoded host data to check if the recorded data is correct or to check if the recorded data is correctable. During the verification, firstly, the defect detection apparatus 20 reads the optical disk 500 and then slice the read information into binary form by a slicer 510, then transmitted to a demodulator 520. The defect detection apparatus 20 of the first embodiment comprises a buffer controller 120, a buffer 130, a byte error detector 140, the memory 200 and a defect verification unit 300.

The demodulator 520 demodulates the binary data received from the slicer 520 to generate the demodulated data. The buffer controller 120 collects the demodulated data (the set of second data) from the demodulator 520 for the byte error detector 140 regarding a byte as a smallest unit and also sends a sector boundary signal extracted from the set of second data derived from the optical disc 500 to the byte error detector 140. The byte error detector 140 compares bytes of the set of second data with the set of first data to generate error information of the set of second data, in this embodiment, a byte error number. The defect verification unit 300 receives the error information to determine whether the data unit is defective according to the error information. In one of the embodiments, if there are more than four byte errors, the defect verification unit 300 determines the data unit is defective. Furthermore, the buffer 130 is controlled by the buffer controller 120 to buffer the set of second data so that the byte error detector 140 can receive the set of second data and the set of first data corresponding thereto from the memory 200 synchronously for checking each byte thereof.

Please refer to the lower part of FIG. 2. The byte error detector 140 further comprises a comparator 141 and a byte error counter 142. The comparator 141 compares each byte of the set of first data with that of the set of second data to determine if the byte of the set of second data has an error or not. The byte error counter 142 counts each byte error of the data unit to obtain the byte error number. With the received sector boundary signal extracted from the set of second data, the byte error counter 142 resets the byte error number to zero. Specifically, if the object, which the defect detection apparatus 20 performs defect verification for is a sector of DVD, then the byte error counter 142 resets the byte error number once receiving the sector boundary signal. In another embodiment when the object of the defect verification is an ECC block of HD-DVD, the byte error counter 142 resets the byte error number by receiving the sector boundary signal sixteen times.

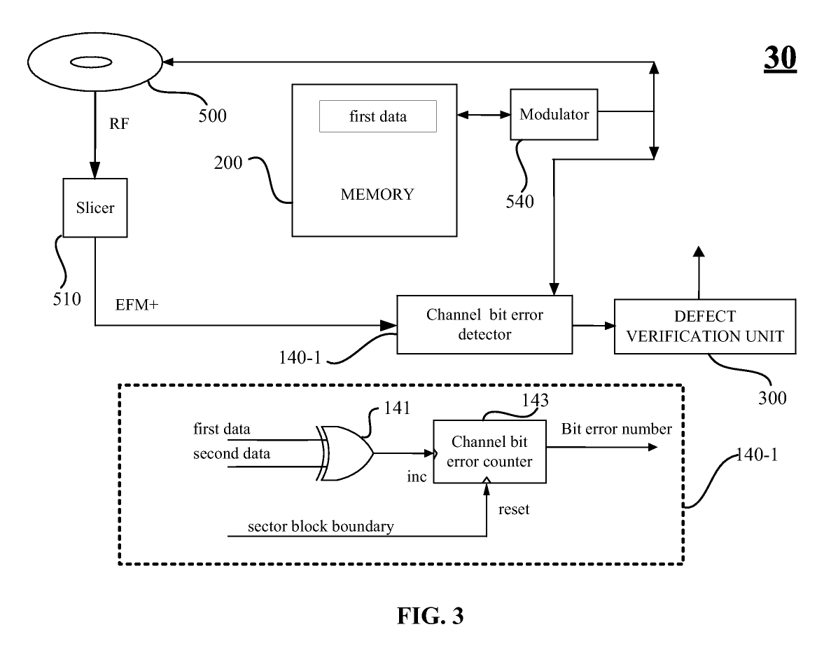

Please refer to FIG. 3, a functional block diagram of the defect detection apparatus 30, comparing a set of first data with a set of second data read from at least one data unit of the optical disc 500 by each channel bit according to a second embodiment of the invention, is shown. The set of first data is a set of encoded and modulated host data prepared for recording onto the data unit of the optical disc 500. The set of second data is a set of binary data directly read from the data unit. In the second embodiment, the defect detection apparatus 30 mainly comprises a channel bit error detector 140-1, a memory 200, a defect verification unit 300 and a modulator 540. In this embodiment, the set of first data stored in a memory 200 is encoded, and then is modulated by the modulator 540 to be the set of encoded and modulated host data. The channel bit error detector 140-1 receives the encoded and modulated host data from the modulator 540 and the set of binary data (channel bit) sliced into pieces by a slicer 510, and then, the channel bit error detector 140-1 compares the channel bits of the set of binary data read from the data unit with those of the set of encoded and modulated host data and generate error information of the set of second data (binary data). The defect verification unit 300 determines whether the data unit is defective according to the error information (channel bit error number). In one of the embodiments, if there are more than ten bite errors, the defect verification unit 300 determines the data unit is defective.

Please refer to the lower part of FIG. 3. The channel bit error detector 140-1 further comprises a comparator 141 and a channel bit error counter 143. The comparator 141 compares each channel bit of the set of first data (encoded and modulated host data) with that of the set of second data (binary data) read from the data unit of the optical disc 500 to determine if the channel bit has an error or not. The channel bit error counter 143 counts each channel bit error of the data unit to obtain the channel bit error number. With the received sector boundary signal extracted from the set of second data read of the optical disc 500, the channel bit error counter 143 resets the channel bit error number to zero. Specifically, if the object, which the defect detection apparatus 30 performs defect verification for is a sector of DVD, then the channel bit error counter 143 resets the channel bit error number once the channel bit error counter 143 receives the sector boundary signal. When the unit of the defect verification is an ECC block of HD-DVD, the channel bit error counter 143 resets the channel bit error number by receiving the sector boundary signal sixteen times.

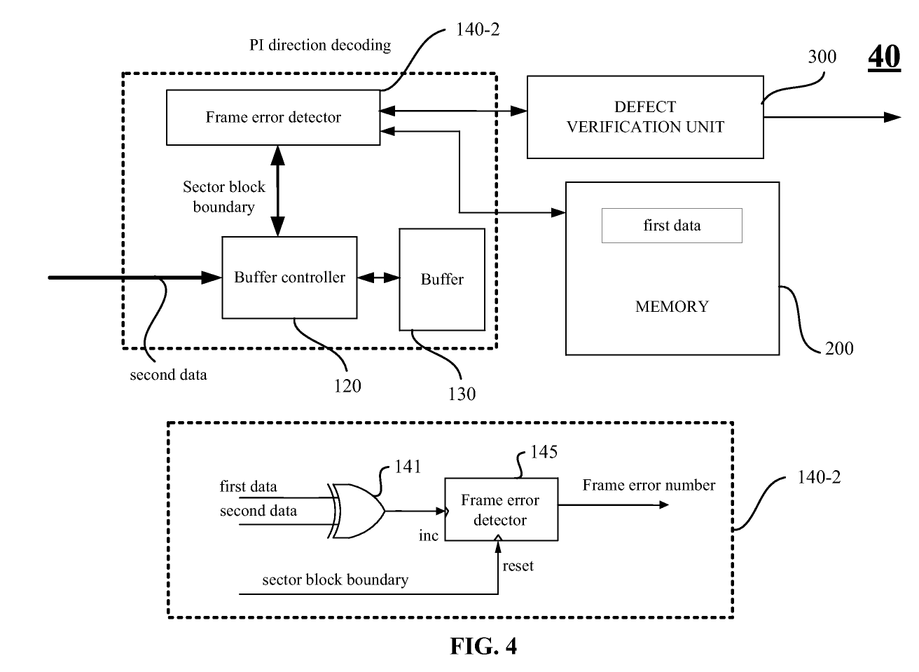

Please refer to FIG. 4, illustrating a functional block diagram of the defect detection apparatus 40, which compares a set of first data with a set of second data derived from at least one data unit of an optical disc by each frame (row) according to a third embodiment of the invention. The set of first data stored in memory 200 is encoded and prepared to record onto the data unit. The set of second data is read and demodulated from the data unit. In the third embodiment, the defect detection apparatus 40 comprises a buffer controller 120, a buffer 130, a frame error detector 140-2, a memory 200 and a defect verification unit 300. As similarly described in the first embodiment, the demodulator 520 (shown in FIG. 2) demodulates the set of second data derived from at least one data unit of the optical disc to generate the demodulated data. The buffer controller 120 collects the demodulated data of the data unit to output the demodulated data for the frame error detector 140-2 regarding a frame as a smallest unit and also sends a sector boundary signal extracted from the set of second data read from the optical disc to the frame error detector 140-2. The frame error detector 140-2 receives the set of first data and the set of second data for comparing the set of first data with the set of second data to generate error information of the set of second data. The defect verification unit 300 determines whether the data unit is defective according to the error information (a frame error number).

Please refer to the lower part of FIG. 4. The frame error detector 140-2 further comprises a comparator 141 and a frame error counter 145. The comparator 141 compares each frame of the set of first data with that of the set of second data derived from the data unit of the optical disc to determine if the frame has an error or not. The frame error counter 145 counts each frame error of the data unit to obtain the frame error number. With the received sector boundary signal extracted from the set of second data read from the optical disc, the frame error counter 145 resets the frame error number to zero. Specifically, if the unit, which the defect detection apparatus 30 performs defect verification for is a sector, then the frame error counter 145 resets the frame error number once the frame error counter 145 receives the sector boundary signal. When the unit of the defect verification is an ECC block, the frame error counter 143 resets the frame error number by receiving the sector boundary signal sixteen times.

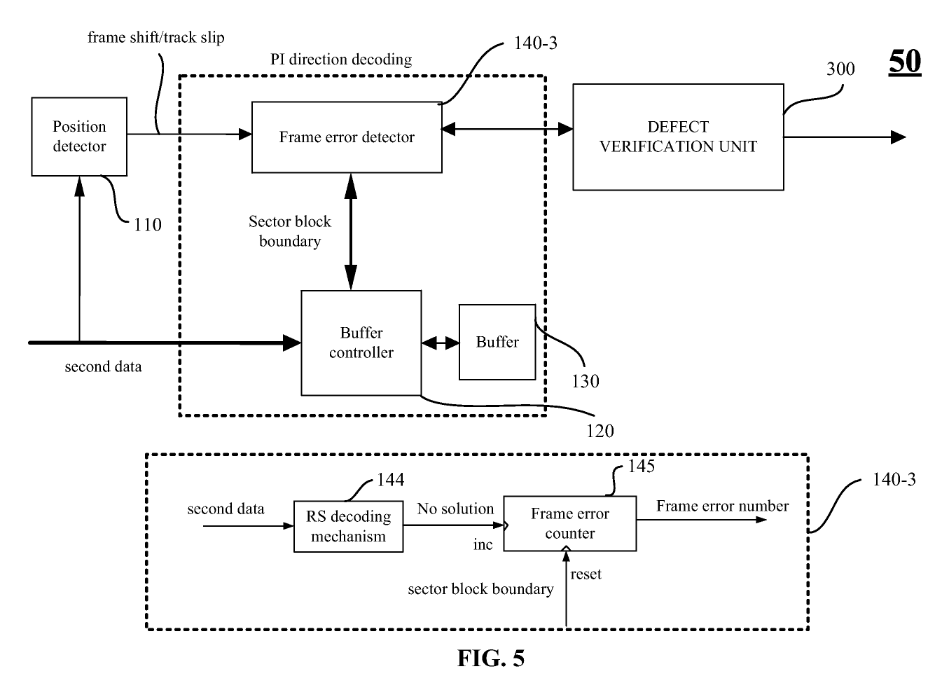

Please refer to FIG. 5, illustrating a functional block diagram of the defect detection apparatus 50, which provides position information (sync pattern information) of each frame for the frame error detector 140-3 according to a fourth embodiment of the invention. In the fourth embodiment, the defect detection apparatus 50 comprises a position detector 110, a buffer controller 120, a buffer 130, a frame error detector 140-3 and a defect verification unit 300. Furthermore, the frame error detector 140-3 comprises a Reed-Solomon decoding mechanism 144 and a frame error counter 145.

Similarly described in the third embodiment, the demodulator 520 (shown in FIG. 2) demodulates the set of second data derived from the data unit to generate the demodulated data. The buffer controller 120 collects the demodulated data of the data unit to output the demodulated data for the frame error detector 140-3 regarding a frame as a smallest unit and also sends a sector boundary signal extracted from the set of second data derived from the optical disc to the frame error detector 140-3. The Reed-Solomon decoding mechanism 144 decodes each frame of the set of second data to determine if the frame has an error or not. The frame error counter 145 counts each frame error of the data unit from the Reed-Solomon decoding mechanism 144 to obtain error information (a frame error number). Moreover, the demodulated data is also transmitted to the position detector 110. The position detector 110 detects a position of the data unit, i.e. tracks every unique sync pattern in the head of each frame and provides sync pattern information of the each frame for the frame error detector 140-3 to ensure the Reed-Solomon decoding mechanism 144 decodes the correct frame in a single direction. The position detector 110 also determines if there is any slip or miss track occurs. Accordingly, the defect verification unit 300 receives the error information (frame error number) from the frame error counter 145 to determine if the data unit is defective.

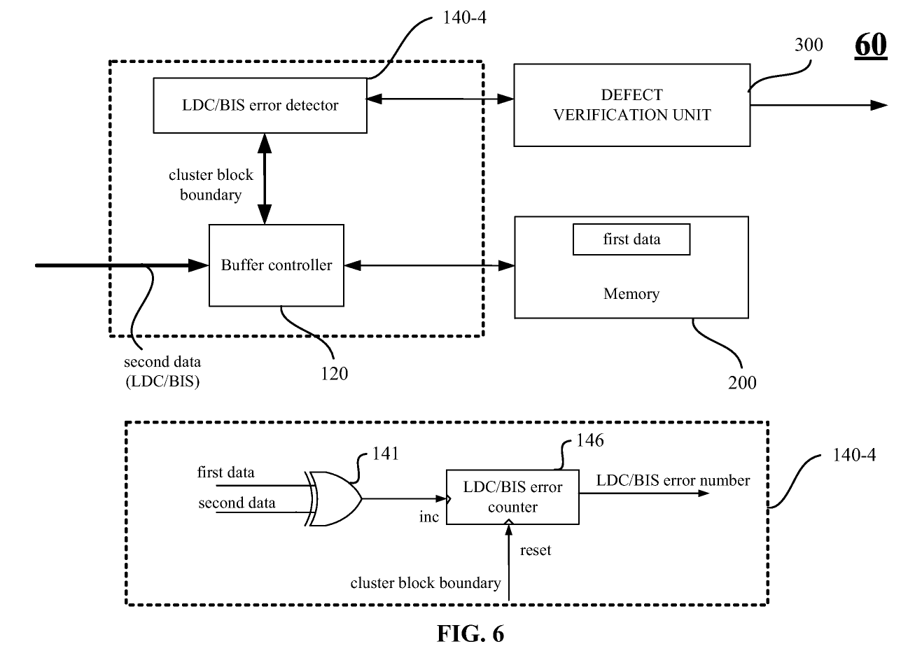

Please refer to FIG. 6, which illustrates a functional block diagram of the defect detection apparatus 60, executing the comparing by each LDC code or each BIS code according to a fifth embodiment of the invention. In the fifth embodiment, the defect detection 60 comprises a buffer controller 120, a LDC/BIS error detector 140-4, a memory 200 and a defect verification unit 300. As similarly described in the embodiments of DVD or HD-DVD, the demodulator 520 (shown in FIG. 2) demodulates the set of second data derived from the data unit of an optical disc to generate a demodulated data. The buffer controller 120 collects the demodulated data of the data unit to store the modulated data to the memory 200 first. The set of first data stored in memory 200 is encoded and prepared to record onto the data unit of the optical disc. The set of second data is demodulated data derived from the data unit. After de-interleaving is done, the buffer controller 120 outputs the set of first data and the set of second data to the LDC/BIS error detector 140-4 regarding a LDC code or a BIS code as a smallest unit and also sends a cluster boundary signal extracted from the data unit read from the optical disc to the LDC/BIS error detector 140-4. Thereafter, The LDC/BIS error detector 140-4 compares LDC codes or BIS codes of the set of first data with those of the set of second data for generating error information (a LDC code error number or a BIS code error number). The defect verification unit 300 determines if the LDC unit or the BIS unit has an error or not. In other words, the defect verification unit 300 determines if the data unit is defective.

Please refer to the lower part of FIG. 6. The LDC/BIS error detector 140-4 further comprises a comparator 141 and a LDC/BIS error counter 146. The comparator 141 compares each LDC unit or each BIS unit of the set of first data with that of the set of second data read from the data unit of the optical disc to determine if the LDC unit or the BIS unit has an error or not. The LDC/BIS error counter 146 counts each LDC unit error or each BIS unit error to obtain the error information (LDC error number or BIS error number). With the received a cluster block boundary signal extracted from the set of second data read from the optical disc, the LDC/BIS error counter 146 resets the LDC error number or the BIS error number to zero. Specifically, if the object of the defect verification is a cluster of Blu-ray disc, the LDC/BIS error counter 146 resets the LDC/BIS error number by receiving the cluster block boundary signal sixteen times.

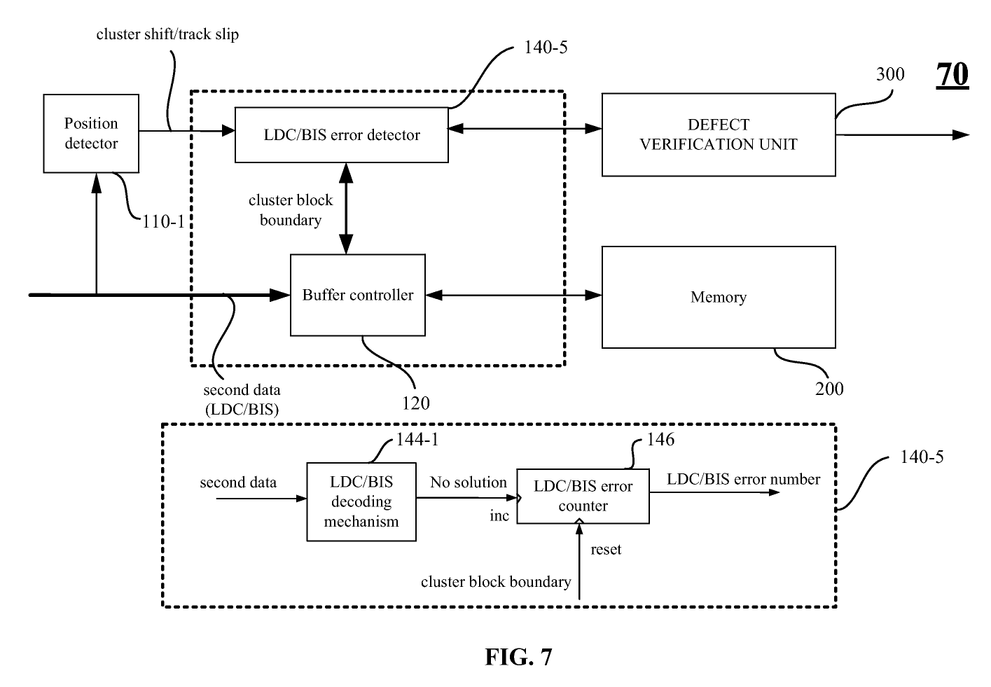

Please refer to FIG. 7, which illustrates a functional block diagram of the defect detection apparatus 70, providing position information (addresses) carried by the BIS code for a LDC/BIS error detector 140-5 according to a sixth embodiment of the invention. In the sixth embodiment, the defect detection apparatus 70 comprises a position detector 110-1, a buffer controller 120, the LDC/BIS error detector 140-5, a memory 200 and a defect verification unit 300. Furthermore, the LDC/BIS error detector 140-4 comprises a LDC/BIS decoding mechanism 144-1 and a LDC/BIS error counter 146. As similarly described in the fifth embodiment, the demodulator 520 (shown in FIG. 2) demodulates the set of second data read from the data unit of an optical disc to generate demodulated data. The buffer controller 120 collects the set of second data of the data unit to store the set of second data to the memory 200 first. After de-interleaving is done, the buffer controller 120 outputs the set of second data to the LDC/BIS error detector 140-5 regarding a LDC code or a BIS code as a smallest unit and also sends a cluster block boundary signal extracted from the set of second data read from the optical disc to the LDC/BIS error detector 140-4. Thereafter, The LDC/BIS decoding mechanism 144-1 decodes each LDC/BIS unit of the set of second data to determine if the LDC/BIS unit has an error or not. The LDC/BIS error counter 146 counts each LDC unit error or each BIS unit error of the data unit from the LDC/BIS decoding mechanism 144-1 to obtain error information (a LDC error number or a BIS error number). Moreover, the set of second data is also transmitted to the position detector 110-1. The position detector 110-1 extracts addresses carried by the BIS code and provides the addresses for the LDC/BIS error detector 140-5 to ensure the LDC/BIS decoding mechanism 144-1 decodes the correct LDC or the correct BIS. Accordingly, the defect verification unit 300 determines if the data unit is defective according to the error information (the LDC error number or the BIS error number) received from the LDC/BIS error counter 146.

Conclusively, the defect detection apparatus of the invention compares the set of first data with set of second data regarding the channel bit, the byte, the frame (row) the LDC or the BIS as the smallest comparing unit, therefore, higher accuracy than prior art can be obtained. Furthermore, providing the position information (sync pattern information) of each frame in the fourth embodiment and providing position information (addresses) carried from the BIS code in the sixth embodiment also can promote accuracy of performing verification. Most significant benefit of the invention is to reduce memory usage while performing verification. Therefore, the memory size in the circuit of the optical disc drive can be minimized.

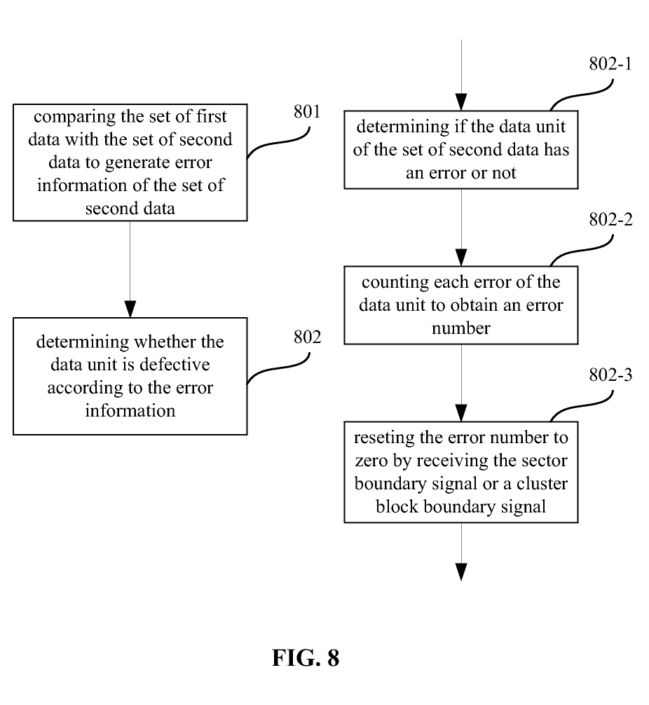

Please refer to FIG. 8, which illustrates a flowchart of a defect detection method for performing verification of the invention. As mentioning in the first, second and third embodiments of the invention, the defect detection method corresponding thereto shown in FIG. 8 comprises steps of:

Step 801: comparing the set of first data with the set of second data to generate error information of the set of second data; and

Step 802: determining whether the data unit is defective according to the error information.

The Step 802 of the defect detection method further comprises steps of:

Step 802-1: determining if the data unit of the set of second data has an error or not;

Step 802-2: counting each error of the data unit to obtain an error number; and

Step 802-3: resetting the error number to zero according to a sector boundary signal or a cluster boundary signal.

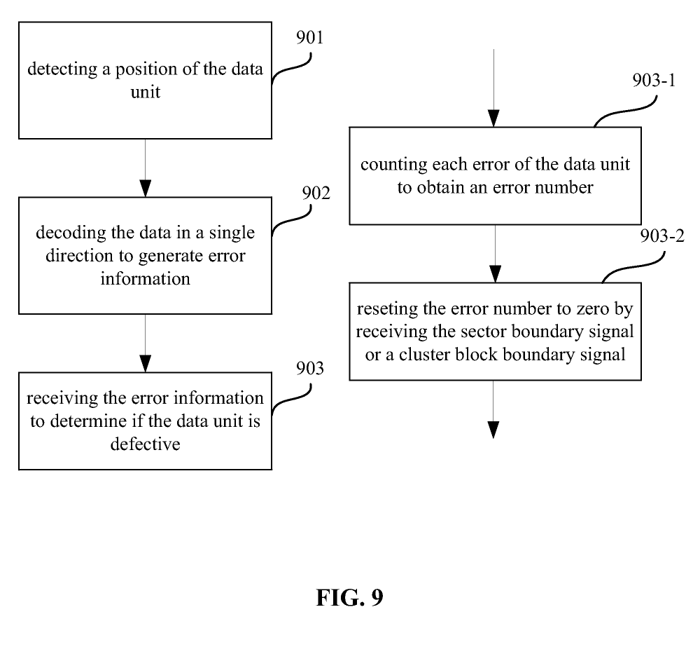

Please refer to FIG. 9, which illustrates a flowchart of another defect detection method for performing verification of the invention. As mentioning in the fourth and sixth embodiments of the invention, the defect detection method corresponding thereto shown in FIG. 9 comprises steps of:

Step 901: detecting a position of the data unit;

Step 902: decoding the data in a single direction to generate error information; and

Step 903: receiving the error information to determine if the data unit is defective.

The Step 903 of the defect detection method further comprises steps of:

Step 903-1 : counting each error of the data unit to obtain an error number; and

Step 903-2: resetting the error number to zero according to a sector boundary signal or a cluster boundary signal. Specifically, the Reed-Solomon decoding mechanism 144 shown in FIG. 5 is employed to decode a frame of the data unit by using a PI or PO direction to determine if the frame has an error or not. For a Blu-ray disc, the LDC/BIS decoding mechanism 144-1 shown in FIG. 7 can be employed to decode a cluster of the data unit by using a BIS or LDC direction to determine if the cluster has an error or not.

As is understood by a person skilled in the art, the foregoing preferred embodiments of the invention are illustrative rather than limiting of the invention. It is intended that they cover various modifications and similar arrangements be included within the spirit and scope of the appended claims, the scope of which should be accorded the broadest interpretation so as to encompass all such modifications and similar structure.

What is claimed is:

1. A defect detection apparatus of an optical disk drive, the optical disc drive recording a set of first data onto at least one data unit of an optical disc, the defect detection apparatus performing verification for a set of second data derived from the data unit of the optical disc after the set of first data being recorded, the defect detection apparatus comprising:
an error detector, for receiving the set of first data and the set of second data, and
comparing the set of first data with the set of second data to generate error information of the set of second data; and
a defect verification unit coupled to the error detector, for determining whether the data unit is defective according to the error information.

2. The defect detection apparatus of claim 1, wherein the set of first data is a set of encoded and modulated host data, and the set of second data is read from the data unit.

3. The defect detection apparatus of claim 2, wherein the error detector is a channel bit error detector for comparing each bit of the set of first data with that of the set of second data.

4. The defect detection apparatus of claim 1, wherein the set of first data is a set of encoded host data, and the set of second data is a set of demodulated data read from the data unit.

5. The defect detection apparatus of claim 4, further comprising a buffer coupled to the error detector for collecting the set of second data and transferring the set of second data to the error detector.

6. The defect detection apparatus of claim 5, wherein the error detector is a byte error detector comparing bytes of the set of first data with those of the set of second data.

7. The defect detection apparatus of claim 5, wherein the error detector is a LDC/BIS error detector comparing LDC codes or BIS codes of the set of first data with those of the set of second data.

8. The defect detection apparatus of claim 1, wherein the data unit is selected from a sector of DVD, an ECC block of HD-DVD and a cluster of Blu-ray disc.

9. The defect detection apparatus of claim 1, wherein the error detector comprises a comparator comparing each data unit of the set of first data with that of the set of second data to determine if the unit of the set of second data has an error or not.

10. The defect detection apparatus of claim 9, wherein the error detector further comprises an error counter counting each error to obtain the error information of the data unit.

11. The defect detection apparatus of claim 9, wherein the unit of the set of first or second data is a bit, a byte, or a data frame.

12. A defect detection method of an optical disk drive, the optical disc drive recording a set of first data onto at least one data unit of an optical disc, the defect detection method performing verification for a set of second data derived from the data unit of the optical disc after the set of first data being recorded, the method comprising steps of:
comparing the set of first data with the set of second data to generate error information of the set of second data; and
determining whether the data unit is defective according to the error information.

13. The defect detection method of claim 12, wherein the set of first data is a set of encoded and modulated host data, and the set of second data is read from the data unit.

14. The defect detection method of claim 12, wherein the set of first data is a set of encoded host data, and the set of second data is a set of demodulated data read from the data unit.

15. The defect detection method of claim 12, wherein the comparing step further compares each unit of the set of first data with that of the set of second data to determine if the unit of the set of second data has an error or not.

16. The defect detection method of claim 15, wherein the unit of the set of first or second data is a bit, a byte, or a data frame.

17. The defect detection method of claim 12, wherein the data unit is selected from a sector of DVD, an ECC block of HD-DVD and a cluster of Blu-ray disc.

18. A defect detection method for performing verification for data read and demodulated from at least one data unit of an optical disc, the method comprising steps of:
detecting a position of the data unit;
decoding the data in a single direction to generate error information; and
receiving the error information to determine if the data unit is defective.

19. The defect detection method of claim 18, wherein the data unit is selected from a sector of DVD, an ECC block of HD-DVD and a cluster of Blu-ray disc.

20. The defect detection method of claim 18, wherein the decoding step uses a Reed-Solomon decoding mechanism to decode a frame of the data unit by using a PI or PO direction to determine if the frame has an error or not.

21. The defect detection method of claim 18, wherein the decoding step uses a LDC/BIS decoding mechanism to decode a cluster of the data unit by using BIS or LDC direction to determine if the cluster has an error or not.
